(19) United States
(12) Patent Application Publication
(10) Pub. No.: US 2008/0314077 A1
(43) Pub. Date: Dec. 25, 2008

(54) Cooler For Transformer Using Generation Cycle

(76) Inventor: Seong-Hwang Rim, Seoul (KR)

Correspondence Address: LAW OFFICE OF BRETT N. DORNY, 386 WEST MAIN STREET, SUITE 12A, NORTHBOROUGH, MA, 01532, US

(21) Appl. No.: 12/092,972

(22) PCT Filed: Mar. 19, 2007
(86) PCT No.: PCT/KR07/01328

§ 371 Date: May 8, 2008

(30) Foreign Application Priority Data
Mar. 22, 2006 (KR) 10-2006-00260026
Jun. 28, 2006 (KR) 20-2006-0017379
Sep. 11, 2006 (KR) 20-2006-0024315

(51) Int. Cl. H01F 27/08

(52) U.S. Cl. 62/513; 336/55

(57) ABSTRACT

The present invention relates to a cooler for a transformer using a generation cycle to eliminate the heat applied to the transformer. The insulation oil heated in the transformer gasifies the refrigerant in the refrigerant boiler and the insulation oil is cooled by the latent heat of evaporation of the refrigerant. The gasified refrigerant exhausts out the heat in the condenser and it becomes liquefied. The liquefied refrigerant returns to the refrigerant boiler by the refrigerant feeding pump or by gravity. The present invention is very effective with respect to operating cost and reliability.

### TECHNICAL FIELD

The present invention relates to the cooler for transformer. The heat applied to the transformer is divided into 2 components. The first is the heat applied from outside of the transformer and the second is the heat of winding loss and core loss that comes in operation of the transformer. These heats give an influence to the temperature of the insulation oil and give an impact to the performance of the winding insulation. And it becomes a key factor of the decision of the capacity and the lifetime of the transformer. We have eliminated the heat applied to the transformer by the cooling methods of ONAN (Natural oil, Natural air cooling), OFAF (Forced oil, Forced air cooling), OFWF (Forced oil, Forced water cooling) and etc. The present invention adopts the generation cycle for the cooling method of the transformer newly.

### BACKGROUND ART

Some people include I have invented the cooler for the transformer using refrigeration cycle. The refrigeration cycle has the merit to lower the temperature of the insulation oil than that of the atmosphere. But the compressor must be in the cycle and it consumes much energy. If the compressor stops, the transformer must stop operation. On the other hand generation cycle does not request the compressor in the cycle and it does not consume any energy. But it has a demerit that the temperature of the insulation oil can not be lowered than that of the atmosphere. The trouble of the compressor is not in the generation cycle. So the generation cycle can be adopted as the method of the cooler for the transformer.

### DISCLOSURE OF INVENTION

### Summary of the Invention

The oil-filled transformer adopts A-class insulation on the winding. The A-class insulation is designed to withstand to the maximum temperature 105° C. and the average temperature 95° C. In the present invention the insulation oil is cooled by the latent heat of vaporization of the refrigerant that is filled in the refrigerant boiler obtain the heat from the transformer. The evaporated refrigerant in the boiler goes into the expansion area and rotates the turbine to generate the energy. And it goes into the condenser to be liquefied eliminating the heat. One of the generation cycles to cool the transformer is finished if the liquefied refrigerant comes into the refrigerant boiler. It is not matter that the temperature of the insulation oil gets to the maximum temperature 105° C. or the average temperature 95° C. to the transformer that is designed as A-class insulation. To adopt the refrigeration cycle that can makes the temperature of the insulation oil be lower than that of the atmosphere in the cooling of the transformer causes over-cooling and increases the probability of the trouble in operation. In the case of the heat-pipe to maintain the vacuum is very difficult and the small pipe type facilities can not cool the large transformer. The generation cycle has the merit that it does not consume any energy and does not have any probability of the trouble from the compressor because it does not need compressor in the cycle. The structure of the cooler becomes very simplified if we omit the generator or the other components. The cooler can be operated by the contact-type refrigerant boiler for the other transformer excluding the oil-filled transformer.

### DETAIL DESCRIPTION OF THE INVENTION

Hereinafter, a preferred embodiment of the present invention will be described in detail with reference to the accompanying drawings.

FIG. 1 illustrates the cooler using the generation cycle adopted in present invention. More than two of the oil circulation pipes 11 are constructed between the transformer body 10 and the refrigerant boiler 13. Minimum one of the oil circulation pump 12 is installed in the line of the oil circulation pipe 11. In this case, the refrigerant boiler 13 is a heat exchanger that the heat exchange between the enforced circulating insulation oil and the refrigerant is executed in. The cycling pipe loop for the refrigerant circulation is constructed in the following sequence; the refrigerant side of the refrigerant boiler 13, the pressure valve 14, the expander 15, the condenser 16, the refrigerant tank 17, the refrigerant feeding pump 18 that the check valve 19 is installed in parallel, the other refrigerant side of the refrigerant boiler 13. The principle of the operation is as follow. The insulation oil in the transformer body 10 circulates the first side of the refrigerant boiler 13 if the oil circulation pump 12 operates. The refrigerant filled in the second side of the refrigerant boiler 13 is evaporated through the heat exchange with the insulation oil circulating the first side of the refrigerant boiler 13. The insulation oil is cooled by the latent heat of evaporation. The gasified refrigerant comes into the expander 15 through the pressure valve 14. The gasified refrigerant in high pressure by the pressure valve 14 executes adiabatic expansion in the expander 15 decreasing pressure. The turbine (un-illustrated) can be installed in the expander 15 and can be rotated by the flow of the gasified refrigerant. The generator (un-illustrated) installed at the other side can generate the energy. The refrigerant that executes adiabatic expansion in the expander 15 is liquefied in the condenser 16 exhausting the heat to the out of the condenser 16. The liquefied refrigerant comes into the refrigerant tank 17. In case that the refrigerant feeding pump 18 is not operated the liquefied refrigerant in the refrigerant tank 17 is feed into the refrigerant boiler 13 through the pipe that the check valve 19 is installed and a cycle of the cooling transformer is finished. In case that the refrigerant feeding pump 18 is operating the liquefied refrigerant in the refrigerant tank 17 is feed into the refrigerant boiler 13 through the feeding pump and a cycle of the cooling transformer is finished. The condenser 16, the refrigerant tank 17, the refrigerant feeding pump 18 that the check valve 19 is installed in parallel, the refrigerant boiler 13 can be constructed in the arrayed sequence from high position to the low position in order to the liquefied refrigerant can be feed into the refrigerant boiler 13 by the gravity. The refrigerant whose boiling temperature is in the range of the operating temperature of the transformer is adopted. The boiling temperature of R-141b is about 32° C., that of R123 is about 28° C., that of AK225 is about 54° C. and that of alcohol is about 78° C. There are many refrigerants whose boiling temperature is in the range of the operating temperature of the transformer. The refrigerant feeding door (un-illustrated) and the air exhausting door (un-illustrated) must be installed at the refrigerant circulation pipe. The condenser 16 can adopt two of the type (the air cooling type and the water cooling type).

FIG. 2 illustrates the P-h graph of the refrigeration cycle. The pressure (Pₑ) and the temperature of the evaporator are lower than those of the condenser. The refrigeration cycle is not effect for the transformer cooling because it is not needed that the temperature of the insulation oil contacted to the evaporator is made lower than the temperature of the atmosphere contacted to the condenser. And the heat (E_{c}) to be exhaust by the condenser is larger than the heat (Eₑ) obtained from the transformer by the heat (Eₚ) corresponding to the work done by the compressor. And the compressor must be installed in the refrigeration cycle.

FIG. 3 illustrates the P-h graph of the generation cycle. The pressure (P_{b}) and the temperature of the boiler are higher than those of the condenser. The generation cycle is effect for the transformer cooling because the temperature of the insulation oil contacted to the boiler is higher than the temperature of the atmosphere contacted to the condenser. And the heat (E_{c}) to be exhaust by the condenser is larger than the heat (E_{b}) obtained from the transformer by the heat (E_{g}) corresponding to the work done by the facility installed in the expander. And the capacity of the condenser is smaller than the refrigeration cycle.

FIG. 4 illustrates the cooler using the generation cycle omitted the expander and the refrigerant tank. It is similar to the FIG. 1 but different that the expander 15 with the pressure valve 14 and the refrigerant tank 17 is omitted. In this case the performance of the cooler using the generation cycle is reduced slightly but the structure becomes very simplified. The gasified refrigerant in the refrigerant boiler 13 goes directly to the condenser 16 and it becomes liquefied exhausting out the heat in here. And the liquefied refrigerant goes to the refrigerant boiler 13 through the refrigerant feeding pump 18 that the check valve 19 is installed in parallel. And a cycle of the cooling transformer is finished.

FIG. 5 illustrates the cooler using the generation cycle only the refrigerant boiler and the condenser are installed. It is similar to the FIG. 4 but different that the refrigerant feeding pump 18 that the check valve 19 is installed in parallel is omitted. In this case the liquefied refrigerant from the condenser 16 goes to the refrigerant boiler 13 and a cycle of the cooling transformer is finished. The structure of the cooler becomes very simple.

FIG. 6 illustrates the cooler using the generation cycle installed the contact-type refrigerant boiler. It is similar to the FIG. 5 but different that the refrigerant boiler 13 absorbs the heat from the transformer by contacting to the transformer body 10. In this case the refrigerant circulation pipe system can adopt that of FIG. 1. FIG. 4, FIG. 5 (un-illustrated). The refrigerant boiler 13 can be contacted to the side or upper plane of the transformer body 10 or the radiator.

FIG. 7 illustrates the cooler using the generation cycle the refrigerant boiler is installed in the transformer body. It is similar to the FIG. 6 but different that the refrigerant boiler 13 is installed in the transformer body 10. If it is not matter in insulation between the refrigerant boiler and the windings the heat exchange will be excellent than that of FIG. 6. The operating principle is the same to FIG. 1 or FIG. 4 and FIG. 5.

FIG. 8 illustrates the cooler using the generation cycle the refrigerant boiler wraps the radiator. The refrigerant boiler 13 is made to wrap the radiator 81. In this case the refrigerant circulation pipe system can adopt that of FIG. 1 or FIG. 4 or FIG. 5 (un-illustrated). If the heat is generated in the transformer the heated insulation oil circulate between the transformer body 10 and the radiator in the refrigerant boiler 13. The refrigerant in the refrigerant boiler 13 becomes gasified. The operating principle is the same to FIG. 1 or FIG. 4 or FIG. 5.

### BRIEF DESCRIPTION OF DRAWINGS

FIG. 1 illustrates the cooler using the generation cycle adopted in present invention

FIG. 2 illustrates the P-h graph of the refrigeration cycle.

FIG. 3 illustrates the P-h graph of the generation cycle.

FIG. 4 illustrates the cooler using the generation cycle omitted the expander and the refrigerant tank.

FIG. 5 illustrates the cooler using the generation cycle only the refrigerant boiler and the condenser are installed.

FIG. 6 illustrates the cooler using the generation cycle installed the contact-type refrigerant boiler.

FIG. 7 illustrates the cooler using the generation cycle the refrigerant boiler is installed in the transformer body.

FIG. 8 illustrates the cooler using the generation cycle the refrigerant boiler wraps the radiator.

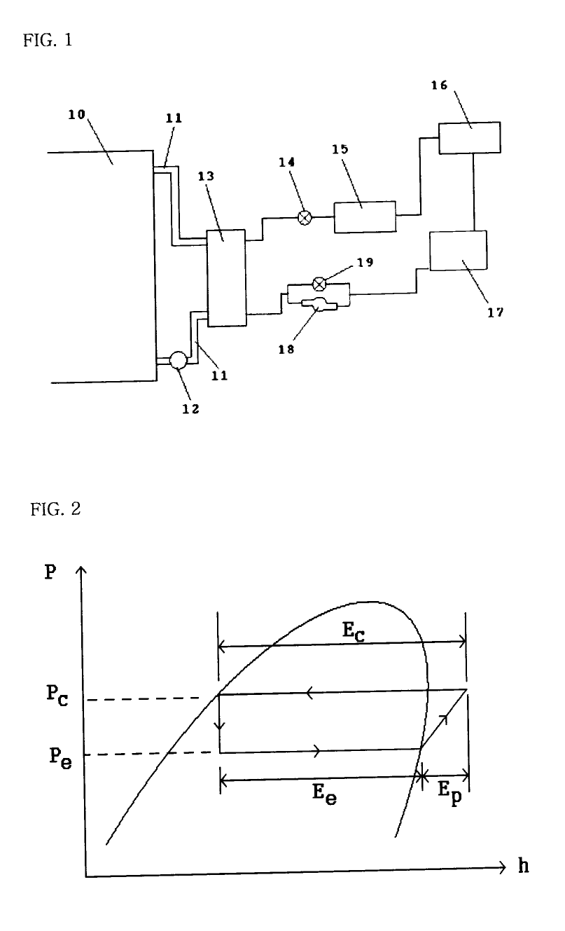

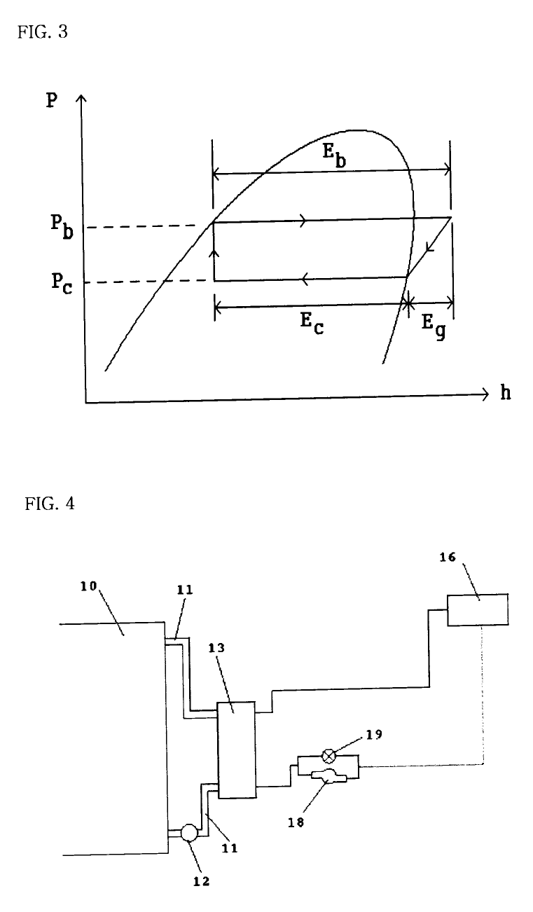

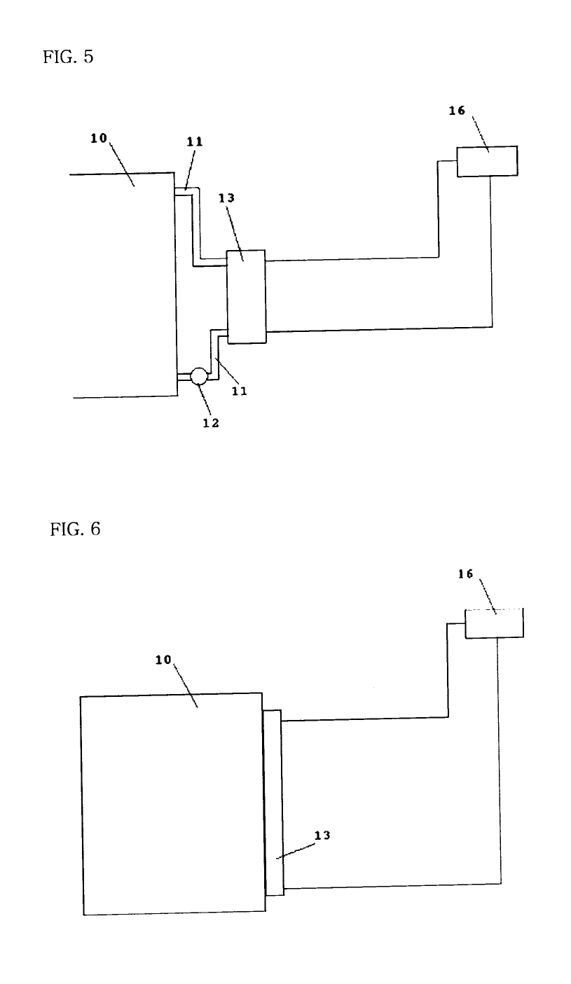

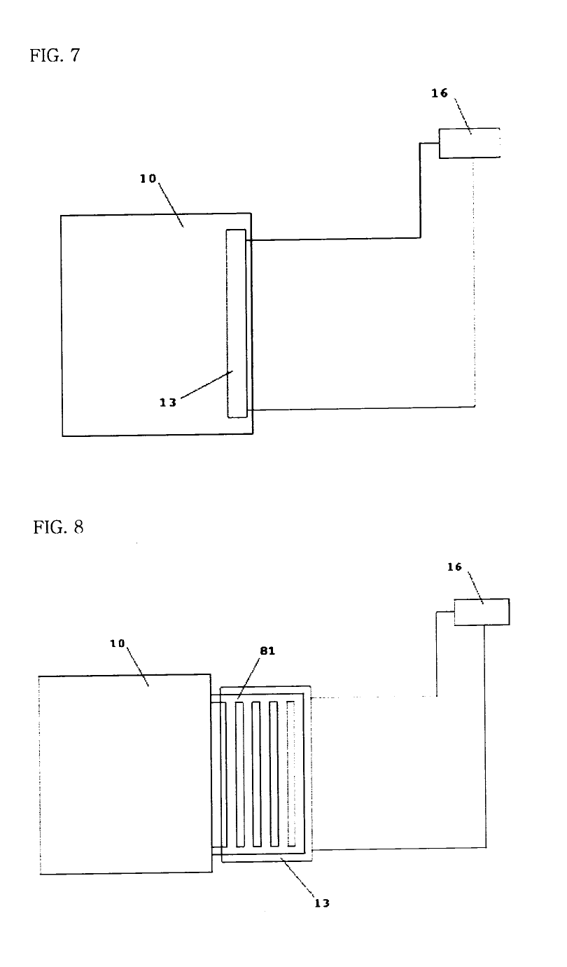

### DESCRIPTION OF THE NUMBER OF THE DRAWINGS

10: transformer body
11: oil circulation pipe
12: oil circulation pump
13: refrigerant boiler
14: pressure valve
15: expander
16: condenser
17: refrigerant tank
18: refrigerant feeding pump
19: check valve
81: radiator

### BEST MODE FOR CARRYING OUT THE INVENTION

The example illustrated in FIG. 4. is the representative application. More than two of the oil circulation pipes 11 are constructed between the transformer body 10 and the refrigerant boiler 13. Minimum one of the oil circulation pump 12 is installed in the line of the oil circulation pipe 11. The cycling pipe loop for the refrigerant circulation is constructed in the following sequence; the refrigerant side of the refrigerant boiler 13, the condenser 16, the refrigerant feeding pump 18 that the check valve 19 is installed in parallel, The condenser 16, the refrigerant feeding pump 18 that the check valve 19 is installed in parallel, the refrigerant boiler 13 can be constructed in the arrayed sequence from high position to the low position in order to the liquefied refrigerant can be feed into the refrigerant boiler 13 by the gravity.

### INDUSTRIAL APPLICABILITY

The cooler according to the present invention is very effective in the point of operating cost and reliability because as it does use the compressor the energy consumption in refrigeration cycle is saved and the probability of the fault does not occur. It can be use the substitution of the water cooler. The field test of the present invention has given good performance.

1. (canceled)

2. (canceled)

3. (canceled)

4. (canceled)

5. (canceled)

6. A cooler for a transformer using a generation cycle comprising:
a refrigerant boiler coupled to the transformer to receive heat therefrom;
a condenser;
pipes connecting the refrigerant boiler and condenser to create a refrigerant circulation loop; and
a refrigerant, having a boiling temperature in the range of the temperature of the transformer, within the refrigerant circulation loop.

7. The cooler for a transformer according to claim 6, wherein the condenser is at a higher position than the refrigerant boiler.

8. The cooler for a transformer according to claim 6, further comprising:
a refrigerant feeding pump 18 between an outlet of the condenser and an inlet of the refrigerant boiler; and
a check valve in parallel with the refrigerant feeding pump.

9. The cooler for a transformer according to claim 8, further comprising:
a pressure valve connected to the outlet of the refrigerant boiler; and
an expander connected to the pressure valve and an inlet of the condenser.

10. The cooler for a transformer according to claim 1, wherein the refrigerant boiler has two liquid spaces for heat exchange, the refrigerant being on one of the liquid spaces,
the cooler further comprising:
oil circulation pipes connecting a body of the transformer with another one of the liquid spaces of the refrigerant boiler; and
an oil circulation pump in line with the oil circulation pipes.

11. The cooler for a transformer according to claim 1, wherein the refrigerant boiler is attached to the outside of a body of the transformer to receive heat therefrom.

12. The cooler for a transformer according to claim 1, wherein the refrigerant boiler is installed in a body of the transformer to receive heat therefrom.

13. The cooler for a transformer according to claim 1, wherein the transformer includes a radiator, and wherein the refrigerant boiler wraps the radiator to receive heat therefrom.
